(19) United States
(12) Patent Application Publication
(10) Pub. No.: US 2008/0075234 A1
(43) Pub. Date: Mar. 27, 2008

(54) METHOD AND APPARATUS FOR INCREASING X-RAY FLUX AND BRIGHTNESS OF A ROTATING ANODE X-RAY SOURCE

(75) Inventors: Leendert J. Seijbel, Rotterdam (NL); Arjen B. Storm, Delft (NL); Gijsbertus J. Kerpershoek, Barendrecht (NL)

Correspondence Address: LAW OFFICES OF PAUL E. KUDIRKA, 40 BROAD STREET, SUITE 300, BOSTON, MA, 02109, US

(73) Assignee: Bruker AXS, Inc., Madison, WI (US)

(21) Appl. No.: 11/533,999

(22) Filed: Sep. 21, 2006

(51) Int. Cl. G01D 18/00

(52) U.S. Cl. 378/207

(57) ABSTRACT

In an X-ray source in which an electron beam spot is focused on a rotating anode, the height of the electron beam spot is reduced as much as practical, the width is increased so that the ratio of the height to the width of the electron beam spot is significantly smaller then the sine of the X-ray takeoff angle. The electron beam is generated by an electron optical configuration obtained by a process involving a combination of testing and simulations. An initial electron optics design is obtained by simulating the electron optics using conventional simulation software. This initial electron optical design is then built into hardware. Extensive measurements are then made on this hardware, and, based on the results of the measurements, new simulations are performed. This process is repeated until an optimum design is obtained.

### BACKGROUND

In conventional X-ray sources X-rays are created by directing an electron beam onto a target anode. Due to the process of creating and filling of holes in the electron structure of the anode material, specific monochromatic X-rays are created in a well-known manner. However, this process also generates a considerable amount of heat in the anode material. In high-power X-ray generation equipment, the heat buildup in the anode material can increase to the point where the anode material melts or is destroyed.

Accordingly, conventional high power X-ray generation equipment typically uses an anode with a large area that is rotated continuously at high speed. This arrangement is schematically illustrated in FIG. 1 which shows a typical rotating anode generator 100. The X-ray generator comprises a cathode 102 and a rotating anode 104 driven by a motor 106. The cathode 102 and the anode 104 are located inside a vacuum chamber 108 that is evacuated by a vacuum pump 110. A power supply 112 generates a filament heating current and a high voltage (typical 30-60 kV) between the filament and the anode. Due to the heat source at the cathode and the high voltage between the cathode and the anode, electrons are generated and accelerated to the rotating anode 104.

The resulting electron beam impinges on only a small spot on the anode and this spot heats up under the electron bombardment. However, the rotation of the anode rapidly moves the spot away from the electron beam and during the rest of the rotation the spot on the anode cools down again. In this manner the power density applied to the anode by the electron beam can be much higher compared to a stationary anode, such as an anode in a sealed tube.

This arrangement is shown in FIG. 2. An electron beam generation apparatus 200 generates an electron beam 202 which impinges on anode 204. Anode 204 rotates in a direction indicated by arrow 206 around axis 210. The electron bombardment, or focal, spot 208 on the anode 206 can be described with two specific parameters, the height h and the width w. The height of the spot is defined in the direction tangential to the anode rotation direction 206 and the width is defined in a direction parallel to the rotation axis 210. In general, the width w of the spot 208 on the anode 206 is larger than the height h. In conventional point focus systems, the ratio of height to the width is set equal to the sine of the takeoff angle 212 of an X-ray beam 214. With this takeoff angle, the width and the height of the X-ray beam 214 are equal and, in case of an elliptical spot 208 on the anode 206, the X-ray beam 214 becomes circular. An example of this conventional arrangement is disclosed in European Patent No. EP 1 273 906 where a long, narrow focal spot of 1 mm×0.1 mm (w×h) is formed on the anode and an X-ray beam is taken out from the spot with the takeoff angle of about six degrees. At that takeoff angle, the apparent focal spot region becomes about 100 μm×100 μm.

FIG. 3 shows this relationship for both line focus beams 308 and 310 and point focus beams 304 and 306 for a rectangular spot 302 on the anode 300 where the ratio between the spot height (hₛₚₒₜ) and the spot width (wₛₚₒₜ) is equal to the sine of the takeoff angle(α).

$$\frac{{h}_{spot}}{{w}_{spot}} = sin α$$

In point focus orientation this arrangement produces beams 304 and 306 with dimensions height (h_{beam}) and width (W_{beam}) according to:

$$\frac{{h}_{beam}}{{w}_{beam}} = 1$$

In line focus orientation the ratio between the beam's height (h_{beam}) and width (W_{beam}) becomes the square of the sine of the takeoff angle α.

$$\frac{{h}_{beam}}{{w}_{beam}} = {sin}^{2} α$$

The electron spot size and configuration can be adjusted using an electron optical configuration such as that shown in FIG. 4. Here an electron beam 404 generated by a filament 406 is focused to a spot 400 on the rotating anode 402 by means of a focus cup 408.

Two important properties of an X-ray source are the X-ray flux and the brightness of the source and it is desirable to maximize both of these properties. The X-ray flux, which is the number of X-ray photons per second created, is linearly related to the power applied to the anode, so a forty percent increase in power increases the X-ray flux by forty percent. Thus, it is desirable to maximize the power applied to the anode.

However, as previously mentioned, due to the energy of the electrons impacting the anode, the rotating anode heats up and, consequently, as the power applied to the anode increases, so does the anode temperature. The electron power P applied to the anode is given by the product of the electron accelerating voltage Uₑ and emission current Iₑ. Depending on the anode material and the characteristic wavelength of the X-rays that is desired, Uₑ is typically on the order of 40 to 60 kilovolts. For conventional rotating anodes, the emission current is of the order of 10 to 100 mA. Therefore, in conventional systems, the electron power P applied to the anode is on the order of a few kilowatts.

The maximum power Pₘₐₓ that can be applied to an anode depends on combined anode properties represented by a parameter α, the width of the spot w, the height of the spot h, the rotational speed of the anode ω, the background temperature of the anode Tₒ and the maximum temperature Tₘₐₓ that the anode can withstand. The maximum power can be determined by the following equation:

Pₘₐₓ=α(Tₘₐₓ−T₀)w\sqrt{ω}\sqrt{h} (1)

Consequently, there is a limit to the maximum power applied to the anode and, accordingly, the maximum X-ray flux.

The brightness of an X-ray source is linearly dependent on the power density PD applied to the anode. The maximum power density PDₘₐₓ is equal to the maximum power that can be applied to the anode divided by the width and the height of the electron spot. Thus PDₘₐₓ is given by:

$${PD}_{max} = \frac{{P}_{max}}{wh} \qquad ( 2 )$$

Therefore, since the ratio of the spot height and width are fixed by the sine of the takeoff angle, both the X-ray flux and the brightness of a source are conventionally limited by the maximum power that can be applied to the anode.

### SUMMARY

In accordance with the principles of the invention, the height of the electron focal spot on the anode is reduced as much as practical, the width is increased so that the ratio of the height to the width of the focal spot is significantly smaller then the sine of the takeoff angle. In this manner, both the X-ray flux and the brightness of the source are maximized.

In one embodiment, an electron optical configuration that produces an optimum spot size is obtained by a process involving a combination of testing and simulations. An initial electron optics design is obtained by simulating the electron optics using conventional simulation software in order to obtain an electron optical setup that produces a spot in the range with which the invention operates. This initial electron optical design is then built into hardware. Extensive measurements are then made on this hardware, and, based on the results of the measurements, new simulations are performed. This process is repeated until an optimum design is obtained.

### BRIEF DESCRIPTION OF THE DRAWINGS

FIG. 1 is a block schematic diagram of a conventional rotating anode X-ray source.

FIG. 2 is a schematic diagram of an electron beam spot on a rotating anode illustrating the conventional relationship of the height and width of an elliptical spot to the X-ray beam takeoff angle.

FIG. 3 is a block schematic diagram illustrating the conventional relationship of the height and width of a rectangular spot on a rotating anode to the X-ray beam takeoff angle.

FIG. 4 is a schematic diagram illustrating a conventional focus cup that can be used to generate electron beam spots with different shapes on a rotating anode.

FIG. 5 is a schematic diagram that illustrates the use of X-ray optics to form an X-ray beam generated by a spot formed on a rotating anode in accordance with the principles of the present invention.

FIG. 6 is a graph illustrating the increase in X-ray flux that results from an increase in electron beam spot width.

FIG. 7 is a flowchart of a process for determining the optimum spot shape and size.

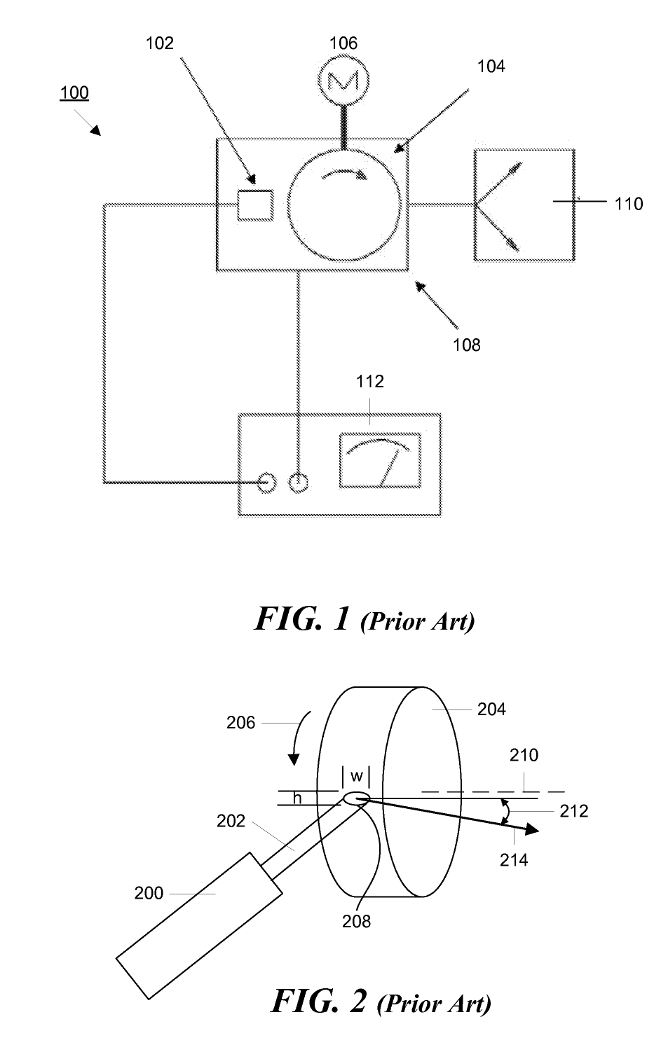

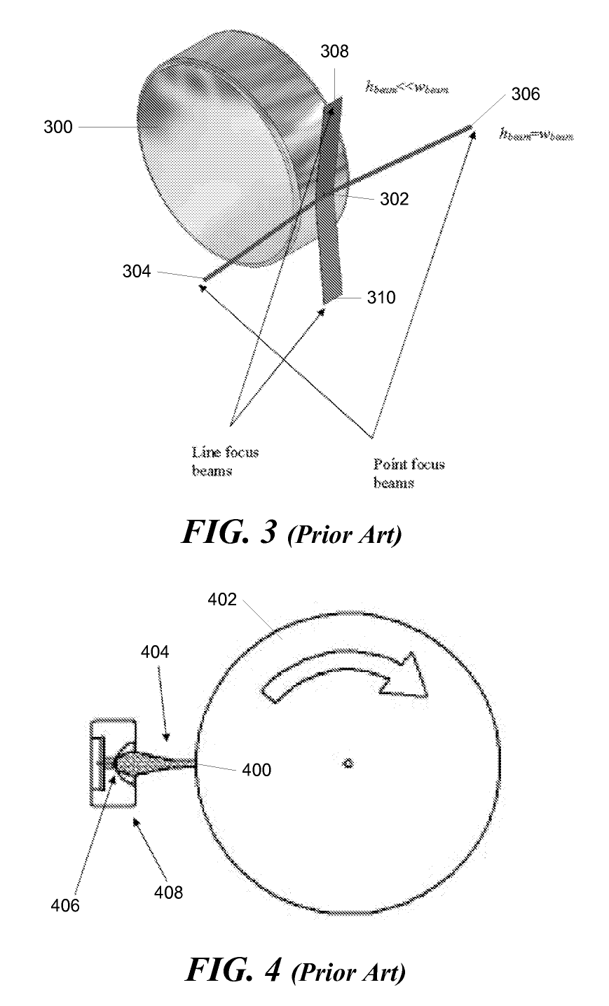

### DETAILED DESCRIPTION

From Equation (1) above it can be seen that the maximum power that can be applied to the anode for a fixed maximum anode temperature increases as the spot width increases. Further, combining equations (1) and (2) set forth above gives:

$${PD}_{max} = \frac{α ( {T}_{max} - {T}_{0} ) \sqrt{ω}}{\sqrt{h}} \qquad ( 3 )$$

Equation (3) indicates that the maximum power density and, thus, the maximum brightness of the X-ray source does not depend on the width w of the electron spot. If the width w of the electron spot is changed (and the power to the anode is changed correspondingly according to Equation (1) in order to maintain the maximum anode temperature) the power density does not change. Further, from equation (3), it can be seen that the power density and, thus, the brightness of the X-ray source increases with decreasing spot height h.

Accordingly, in accordance with the principles of the invention, the height of the electron focal spot on the anode is reduced as much as practical, the width is increased and the takeoff angle is selected so that the ratio of the height to the width of the focal spot is significantly smaller than the sine of the takeoff angle. There is limit to decreasing the spot height. The smallest useable spot heights for rotating anodes are typically in the range from 50 to 100 μm. As an example, in accordance with the principles of the invention, an elliptic long focal spot can be formed on the anode with a height of 90 μm and a width of 1.2 mm and an X-ray beam is taken out from the spot where the width is projected (point focus) under a takeoff angle of about six degrees. In this case, the apparent focal spot region becomes an ellipse with axes lengths of 120 μm and 90 μm which is called a “stretched” spot. It should be noted that a stretched spot is not the same as a line focus because in a line focus the height of the electron spot on the anode is projected under the takeoff angle. The advantages of stretched spot profiles are that they produce more X-ray flux in the beam at the same brightness as conventional spots. At the same time they result in an increased beam stability. In addition, since the beam is larger in one direction, the allowed displacement of optical elements defining the beam can be larger as well. Further, since the area of the beam is larger, larger samples can be analyzed.

In modern X-ray diffraction experiments the X-ray source is used in combination with a multilayer optic. X-rays generated by the source are targeted to the multilayer. X-rays fulfilling the Bragg angle condition of the multilayer are then directed towards the sample. Due to the limited width of the Bragg peak of the multilayer, only a portion of the X-rays generated from the source are directed towards the sample and accordingly the part of the electron spot that the multilayer accepts is limited to an effective size. This practical limitation will, in turn, limit the total flux in the beam and the beam size.

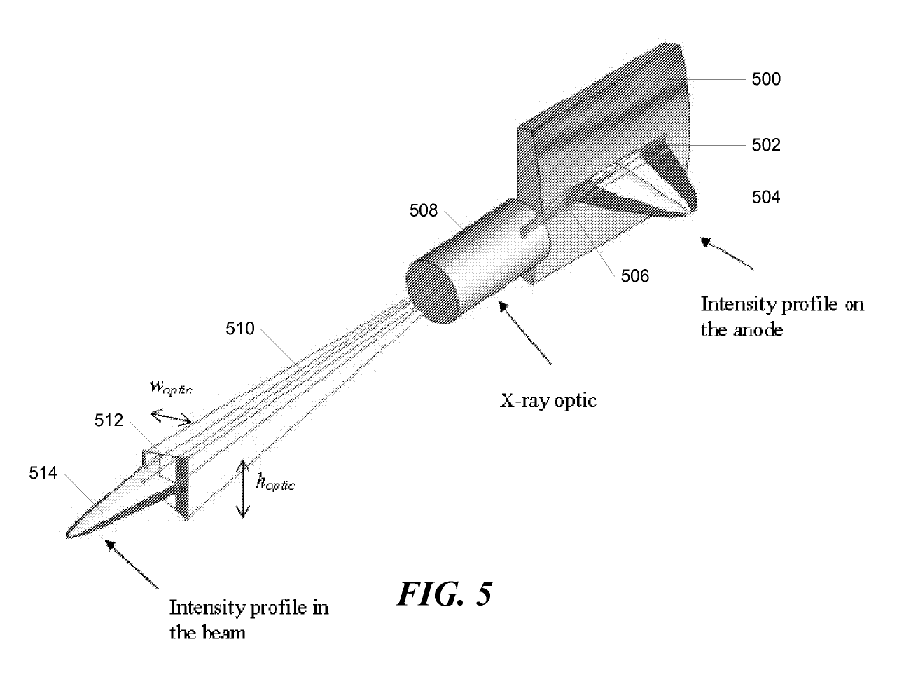

FIG. 5 shows the results of a simulation of X-ray beam formation by an elliptical multilayer X-ray optic. The electron optics (not shown in FIG. 5) are adjusted to generate a rectangular spot 502 on rotating anode 500, a portion of which is illustrated in FIG. 5. The electron intensity has a maximum in the middle of the spot and tapers off at the edges as indicated schematically by the intensity profile graph 504. By increasing the width of the electron spot 502 on the anode 500, the total power applied to the anode is increased according to Equation (1). As previously mentioned, the brightness of the beam is not changed and the X-ray flux increase scales exactly with the increase in beam width.

The spot height, the spot width and the takeoff angle are adjusted so that the ratio of the spot height to the spot width is less than the sine of the takeoff angle:

$$\frac{{h}_{spot}}{{w}_{spot}} < sin α$$

Such a spot will produce (in point focus orientation) a rectangular X-ray beam 506 with a height/width ratio equal to the height divided by the product of width and sine of the takeoff angle:

$$\frac{{h}_{beam }}{{w}_{beam}} = \frac{{h}_{spot}}{{w}_{spot}} \frac{1}{sin α}$$

Therefore, the ratio of the height of the X-ray beam to the width of the X-ray beam is less than one. The beam 506 is then reflected from X-ray optics 508 towards the sample (not shown in FIG. 5). After reflection from the multilayer optics 508, the height h_{optic} and width w_{optic} ratio of the beam 510 will be closer to 1 but still less than one:

$$\frac{{h}_{beam}}{{w}_{beam}} < \frac{{h}_{optic}}{{w}_{optic}} < 1$$

When the beam is passed through the X-ray optics 508, the resulting beam 510 is not round but somewhat distorted as indicated at 512 and the intensity is no longer symmetrical as indicated schematically by graph 514. However, it has been found that the beam distortion does not influence the quality of the X-ray diffraction experiment in a negative way.

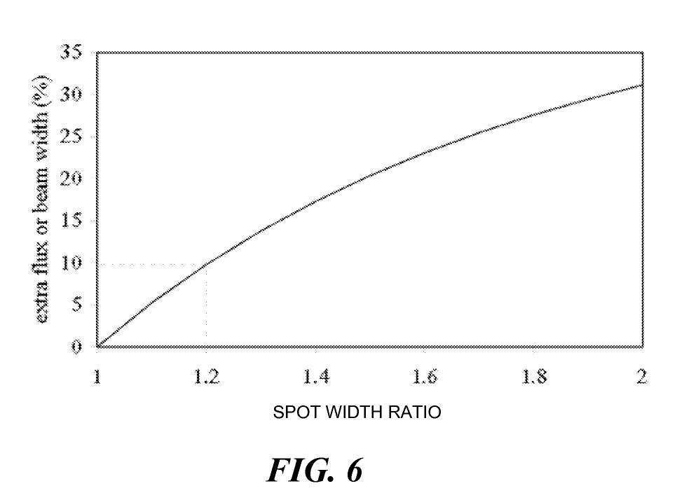

FIG. 6 is a graph that illustrates the results of a simulation and shows the X-ray flux as a function of the ratio of the actual electron beam width and the beam width resulting in a round spot. An electron spot on a rotating anode of 0.1×1 mm² was chosen as a reference and the graph shows the results of increasing the spot width in relation to the reference. Thus, the horizontal axis is the ratio of the electron spot width to the width of the reference spot. The vertical axis represents the increase in X-ray flux. In the simulation the power scales linearly with the electron spot width w according to Equation (1). For example, a stretched spot with twenty percent more power and a size of 0.1×1.2 mm² has ten percent more flux and the resulting X-ray beam is also ten percent wider. Since the brightness of the X-ray beam doesn't change by stretching the spot, the relative change in X-ray beam width is the same as the relative change in the X-ray flux. Simulations show that the increase in X-ray flux and beam width do reach a limit. In aforementioned example, the increase of X-ray flux and beam width reaches a limit of approximately fifty percent for an infinitely stretched electron spot on the anode.

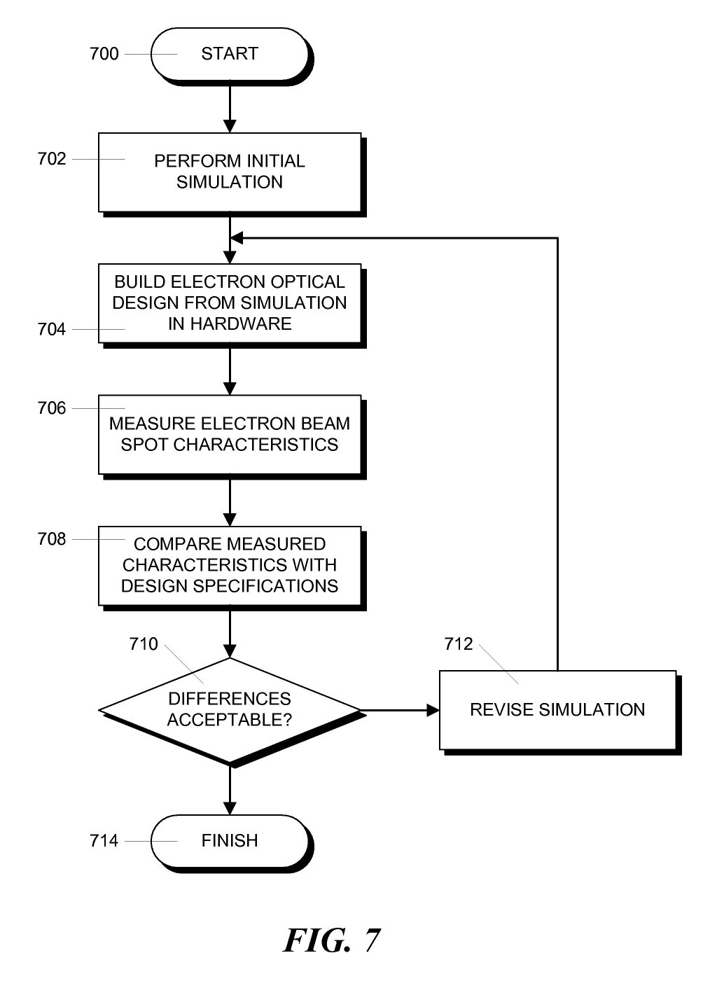

In another embodiment, the optimum spot size and shape is obtained by a process consisting of a combination of testing and simulations. This process is illustrated in FIG. 7. The process begins in step 700 and proceeds to step 702 where an initial electron optics simulation 702 is performed from initial design specifications using a conventional method, such as the Finite Elements Method, the Finite Difference Method or the Surface Charge Method (also known as Boundary Element Method and Charge Density Method). Other well-known methods could also be used. The initial simulation produces an electron optical design generating a spot that is likely to meet the initial design specifications. In step 704, the electron optical design resulting from the simulation is built in hardware.

In step 706, extensive tests can be performed on the hardware to measure the electron beam spot characteristics. In step 708, the measured characteristics are compared to the design specifications. If the differences between the measured characteristics and the design specification are acceptable as determined in step 710, then the electron optical design is finished in step 714.

Alternatively, if, in step 710, it is determined that the differences between the measured characteristics and the design specification are not acceptable, then, in step 712, the current simulation is revised. The process then proceeds back to step 704 where new hardware is built from the revised design. Steps 704-712 are repeated until the design is found acceptable in step 710. For electron optics specialists this loop may converge very rapidly. For experienced specialists only one simulation may be necessary, at most two.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A method for increasing X-ray flux and brightness of an X-ray source in which an X-ray beam is taken off a rotating anode at a takeoff angle, the method comprising generating a stretched electron beam spot having a height and a width on the rotating anode wherein the height is below a predetermined maximum and the width has a value so that the ratio of the height to the width is less than the sine of the takeoff angle.

2. The method of claim 1 wherein the predetermined maximum is 0.1 mm.

3. The method of claim 1 wherein the width of the electron spot is at least 1.0 mm.

4. The method of claim 1 wherein the ratio of the width to the height times the sine of the takeoff angle is in the range of 1.05 to 2.

5. The method of claim 1 further comprising reflecting the X-ray beam off multilayer X-ray optics.

6. The method of claim 1 further comprising reflecting the X-ray beam off a monochromator.

7. The method of claim 1 further comprising reflecting the X-ray beam off capillary optics.

8. A method for designing electron optics for an X-ray source in which an X-ray beam is taken off a rotating anode at a takeoff angle, the method comprising:
(a) performing an initial simulation of electron optics that can generate a stretched electron beam spot having a height and a width on the rotating anode wherein the height is below a predetermined maximum and the width has a value so that the ratio of the height to the width is less than the sine of the takeoff angle;
(b) based on the results of the simulation in step (a), building electron optics to generate the stretched electron spot;
(c) performing measurements on an electron spot generated by the electron optics built in step (b);
(d) determining from the measurements whether the height of the electron spot generated by the electron optics is below a predetermined maximum and the width of the electron spot generated by the electron optics has a value so that the ratio of the height to the width is less than the sine of the takeoff angle; and
(e) when the height and width of the electron spot do not meet the criteria set forth in step (d) revising the simulation used in step (a) and repeating steps (b)-(d).

9. The method of claim 8 wherein step (a) comprises using a Finite Elements Method to perform the simulation.

10. The method of claim 8 wherein step (a) comprises using a Finite Difference Method to perform the simulation.

11. The method of claim 8 wherein step (a) comprises using a Surface Charge Method to perform the simulation.

12. Apparatus for increasing X-ray flux and brightness of an X-ray source in which an X-ray beam is taken off a rotating anode at a takeoff angle, the apparatus comprising:
an electron beam source that generates an electron beam spot having a height and a width on the rotating anode; and
means for adjusting the electron beam spot so that the height is below a predetermined maximum and the width has a value so that the ratio of the height to the width is less than the sine of the takeoff angle.

13. The apparatus of claim 12 wherein the predetermined maximum is 0.1 mm.

14. The apparatus of claim 12 wherein the width of the electron spot is at least 1.0 mm.

15. The apparatus of claim 12 wherein the ratio of the width to the height times the sine of the takeoff angle is in the range of 1.05 to 2.

16. The apparatus of claim 12 further comprising means for reflecting the X-ray beam off multilayer X-ray optics.

17. The apparatus of claim 12 further comprising means for reflecting the X-ray beam off a monochromator.

18. The apparatus of claim 12 further comprising reflecting the X-ray beam off capillary optics.

19. Apparatus for designing electron optics for an X-ray source in which an X-ray beam is taken off a rotating anode at a takeoff angle, the apparatus comprising:
means for performing an initial simulation of electron optics that can generate a stretched electron beam spot having a height and a width on the rotating anode wherein the height is below a predetermined maximum and the width has a value so that the ratio of the height to the width is less than the sine of the takeoff angle;
means responsive to the results of the simulation, for building electron optics to generate the stretched electron spot;
means for performing measurements on an electron spot generated by the electron optics to generate measurement data; and
means responsive to the measurement data and operable when the height of the electron spot generated by the electron optics is above a predetermined maximum and the width of the electron spot generated by the electron optics has a value so that the ratio of the height to the width is greater than the sine of the takeoff angle for controlling the means for performing a simulation to perform an additional simulation, the means for building to build additional electron optics based on the additional simulation and the means for performing measurements to perform measurements on the additional electron optics.

20. The apparatus of claim 19 wherein the means for performing an initial simulation of electron optics comprises means for performing a simulation using one of a Finite Elements Method, a Finite Difference Method and a Surface Charge Method.
